(19) United States
(12) Patent Application Publication
(10) Pub. No.: US 2026/0298297 A1
(43) Pub. Date: Oct. 1, 2026

(54) ELECTROMAGNETIC CLUTCH

(71) Applicant: JTEKT CORPORATION, Kariya-shi (JP)

(72) Inventors: Hiroshi TAKUNO, Nukata-gun, Aichi (JP); Kazuaki KAMIMURA, Takahama-shi, Aichi (JP); Yuta KIKUYA, Kariya-shi (JP); Hiroyuki INOUE, Anjo-shi, Aichi (JP)

(73) Assignee: JTEKT CORPORATION, Kariya-shi (JP)

(21) Appl. No.: 19/143,189

(22) PCT Filed: Jan. 16, 2023
(86) PCT No.: PCT/JP2023/001015

§ 371 Date: Jun. 25, 2025

(51) Int. Cl. F16D 27/14; F16D 27/10

(52) U.S. Cl. CPC F16D 27/14; F16D 27/10; F16D 2300/06

(57) ABSTRACT

An electromagnetic clutch includes an annular electromagnetic coil, a yoke that holds the electromagnetic coil, a magnetic path forming member that forms a magnetic path for a magnetic flux generated by a current flowing through the electromagnetic coil, and an armature to be attracted toward the magnetic path forming member by the magnetic flux. A pump portion that generates a flow of lubrication oil between the yoke and the magnetic path forming member is formed. The pump portion includes an inner tapered portion having a tapered outer circumferential surface, and an outer tapered portion having a tapered inner circumferential surface that faces the tapered outer circumferential surface across a clearance. The inner tapered portion is formed on one of the magnetic path forming member and the yoke, and the outer tapered portion is formed on the other of the magnetic path forming member and the yoke.

### TECHNICAL FIELD

The present invention relates to an electromagnetic clutch for use in an oil-bath state.

### BACKGROUND ART

Hitherto, an electromagnetic clutch that operates an armature by causing a current to flow through an electromagnetic coil held by a yoke to connect or disconnect torque has been provided in, for example, a driving force transmission system of a vehicle. Patent Document 1 describes a driving force transmission device including an electromagnetic clutch as a pilot clutch mechanism.

The driving force transmission device described in Patent Document 1 includes an outer case including a bottomed cylindrical front housing having an opening at one end, and a rear housing screwed into the opening of the front housing. This outer case houses an inner shaft, a main clutch mechanism, a cam mechanism, and the pilot clutch mechanism. The main clutch mechanism includes a plurality of outer clutch plates splined to the inner circumferential surface of the front housing, and a plurality of inner clutch plates splined to the outer circumferential surface of the inner shaft. Frictional sliding between these clutch plates is lubricated by lubrication oil.

The cam mechanism includes a first cam member, a second cam member, and a plurality of cam elements disposed between the first cam member and the second cam member. A cam thrust for pressing the main clutch mechanism is generated by relative rotation of the first cam member and the second cam member. The pilot clutch mechanism includes an electromagnet held by the yoke, a friction clutch, and an armature. The friction clutch is disposed between the rear housing and the armature, and is pressed toward the rear housing by the armature when a current is supplied to the electromagnet. When the friction clutch is pressed, torque is transmitted from the front housing to the first cam member via the friction clutch to cause the first cam member to rotate relative to the second cam member, and the second cam member presses the main clutch mechanism.

The rear housing has an annular recess that is recessed in an axial direction, and the electromagnet is housed in this annular recess while being supported by the yoke. Inner and outer gaps (clearances) are provided between the inner circumferential surface and the outer circumferential surface of the yoke and the inner surface of the annular recess. When the electromagnet is energized, a magnetic path is formed to circulate through the yoke, the inner gap, the rear housing, the friction clutch, the armature, the friction clutch, the rear housing, the outer gap, and the yoke. In the rear housing, an annular cylinder made of a non-magnetic material is embedded in the radially middle portion thereof, and functions as a magnetic path forming member that forms a magnetic path for a magnetic flux.

In the driving force transmission device described in Patent Document 1, hardened layers are formed by nitrocarburizing on the surface layers of the rear housing and the yoke in the portions facing both the gaps. The hardened layer has a hardness that prevents foreign matter such as iron powder that has entered the gap from biting into it. Even if the foreign matter enters the gap, accumulation of the foreign matter in the gap is suppressed.

### CITATION LIST

### Patent Literature

Patent Document 1: JP 2002-219966 A

### SUMMARY OF INVENTION

### Technical Problem

In the technology described in Patent Document 1, the hardened layers are formed on the rear housing and the yoke by nitrocarburizing to suppress the adverse effect of foreign matter that has entered the gap between them. Since this hardened layer is non-magnetic, the formation of the hardened layer increases the magnetic resistance of the magnetic path, resulting in a decrease in magnetic characteristics. Further, man-hours for the nitrocarburizing increases, and the manufacturing cost increases. An object of the present invention is to provide an electromagnetic clutch that can prevent foreign matter from accumulating between a yoke and a magnetic path forming member without forming hardened layers on the yoke and the magnetic path forming member.

### Solution to Problem

In order to achieve the above object, the present invention provides an electromagnetic clutch including an annular electromagnetic coil, a yoke that holds the electromagnetic coil, a magnetic path forming member that forms a magnetic path for a magnetic flux generated by a current flowing through the electromagnetic coil, and an armature to be attracted toward the magnetic path forming member by the magnetic flux. The magnetic path forming member is configured to rotate relative to the yoke in an oil-bath state. A pump portion that generates a flow of lubrication oil between the yoke and the magnetic path forming member is formed by part of each of the magnetic path forming member and the yoke. The pump portion includes an inner tapered portion having a tapered outer circumferential surface, and an outer tapered portion having a tapered inner circumferential surface that faces the tapered outer circumferential surface across a clearance. The inner tapered portion is formed on one of the magnetic path forming member and the yoke, and the outer tapered portion is formed on the other of the magnetic path forming member and the yoke.

### Advantageous Effects of Invention

The electromagnetic clutch according to the present invention can prevent foreign matter from accumulating between the yoke and the magnetic path forming member.

### BRIEF DESCRIPTION OF DRAWINGS

FIG. 1 is a schematic configuration diagram schematically showing an example of the configuration of a vehicle including a driving force transmission device including an electromagnetic clutch according to an embodiment of the present invention.

FIG. 2 is a sectional view showing the driving force transmission device housed in a housing portion of a transfer case together with a first shaft and a second shaft.

FIG. 3 is an enlarged view showing an enlargement of part of FIG. 2.

FIG. 4 is a main part enlarged view showing a further enlargement of portion A in FIG. 3.

### DESCRIPTION OF EMBODIMENTS

### Embodiment

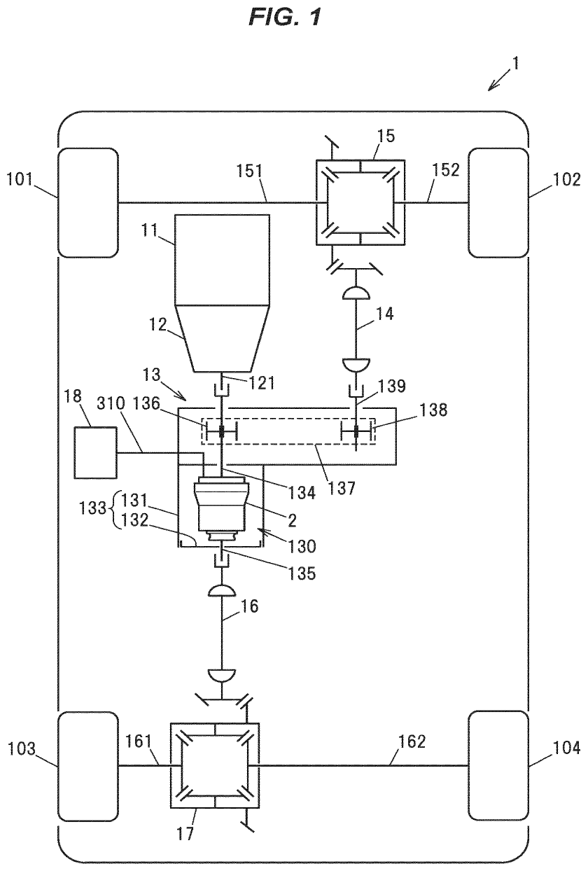

An embodiment of the present invention will be described with reference to FIGS. 1 to 4. The embodiment described below is shown as a suitable specific example for carrying out the present invention, and part of the embodiment specifically illustrates various technically preferable technical matters. However, the technical scope of the present invention is not limited to such specific aspects.

FIG. 1 is a schematic configuration diagram schematically showing an example of the configuration of a vehicle 1 including a driving force transmission device 2 including an electromagnetic clutch according to the embodiment of the present invention. This vehicle 1 is a four-wheel drive vehicle that can drive left and right front wheels 101, 102 and left and right rear wheels 103, 104. The vehicle 1 includes an engine 11 as a drive source. Rotation of an output shaft of the engine 11 is changed in speed by a transmission 12 and output to a transfer 13. The drive source may be an electric motor, or a so-called hybrid system including an engine and an electric motor in combination.

In the present embodiment, the driving force of the engine 11 is constantly transmitted to the front wheels 101, 102, and the driving force of the engine 11 is transmitted to the rear wheels 103, 104 depending on vehicle conditions. That is, in the present embodiment, the front wheels 101, 102 are main drive wheels, and the rear wheels 103, 104 are auxiliary drive wheels. The driving force is transmitted to the rear wheels 103, 104, for example, during acceleration or when the front wheels 101, 102 slip.

The vehicle 1 includes a propeller shaft 14 and a differential device 15 on the front wheel side. The propeller shaft 14 on the front wheel side transmits, to the differential device 15, the driving force output from the transfer 13 to the front wheel side. The differential device 15 distributes the driving force input from the propeller shaft 14 to the left and right front wheels 101, 102 via left and right drive shafts 151, 152.

The vehicle 1 includes a propeller shaft 16 and a differential device 17 on the rear wheel side. The propeller shaft 16 on the rear wheel side transmits, to the differential device 17, the driving force output from the transfer 13 to the rear wheel side. The differential device 17 distributes the driving force input from the propeller shaft 16 to the left and right rear wheels 103, 104 via left and right drive shafts 161, 162.

The transfer 13 includes a transfer case 133 including a case body 131 and a case cover 132. The transfer case 133 includes a housing portion 130 that houses the driving force transmission device 2. The housing portion 130 is filled with lubrication oil. The driving force transmission device 2 is disposed in an oil-bath state within the housing portion 130, and is controlled by a control device 18. The control device 18 controls the driving force transmission device 2 according to the magnitude of a current to be supplied to the driving force transmission device 2.

The driving force transmission device 2 transmits a driving force according to the current supplied from the control device 18 from a first shaft 134 to a second shaft 135. The first shaft 134 is connected to an output shaft 121 of the transmission 12, and the second shaft 135 is connected to the propeller shaft 16 on the rear wheel side. The first shaft 134 is an input shaft of the driving force transmission device 2, and the second shaft 135 is an output shaft of the driving force transmission device 2.

The driving force of the engine 11 is transmitted to the propeller shaft 14 on the front wheel side via a drive sprocket 136 fixed to the first shaft 134, a transfer chain 137 looped around the drive sprocket 136, a driven sprocket 138 around which the transfer chain 137 is looped, and a front-wheel side output shaft 139 to which the driven sprocket 138 is fixed.

The driving force is transmitted to the propeller shaft 16 on the rear wheel side via the driving force transmission device 2, and the driving force that is not transmitted to the propeller shaft 16 on the rear wheel side is transmitted to the propeller shaft 14 on the front wheel side. The driving force transmission device 2 transmits a larger driving force as the current supplied from the control device 18 increases. The control device 18 adjusts the current to be supplied to the driving force transmission device 2 according to vehicle conditions such as rotation speeds of the front wheels 101, 102 and the rear wheels 103, 104, a vehicle speed, an accelerator pedal operation amount, and a yaw rate, and controls the driving force transmission device 2.

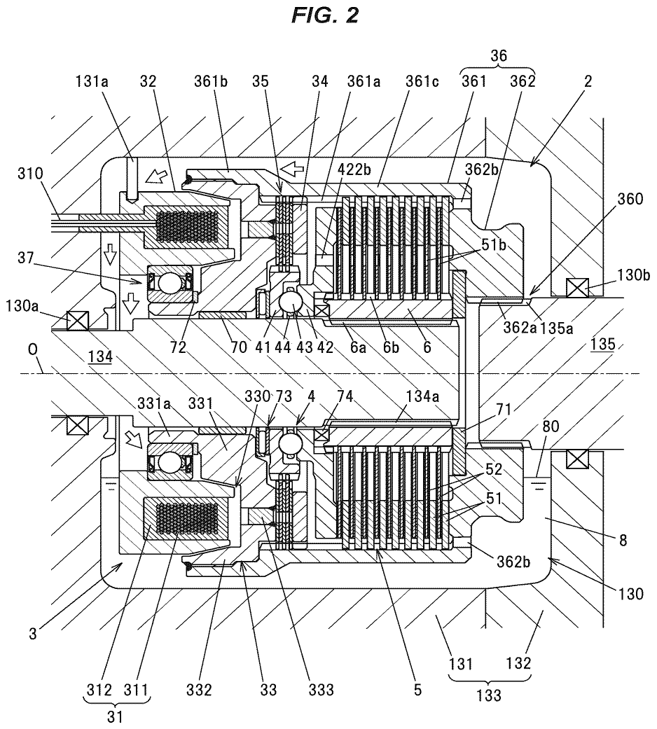

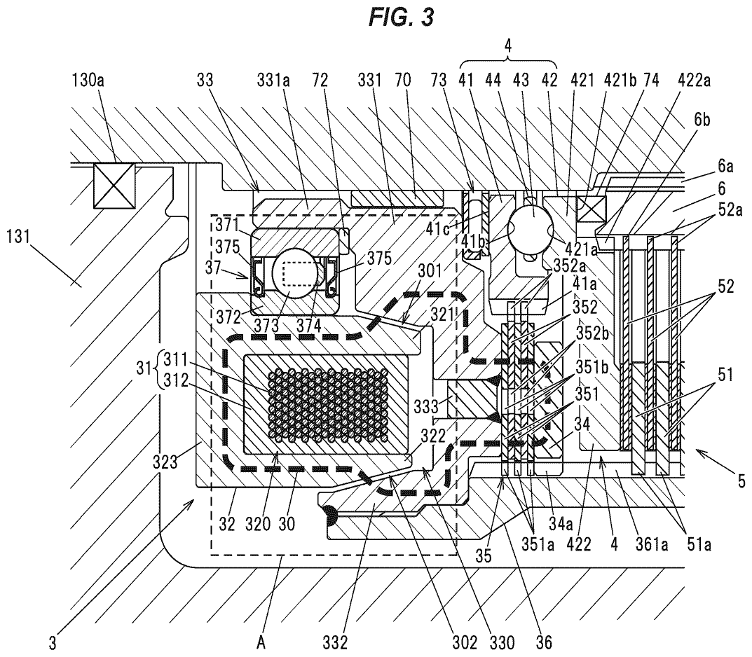

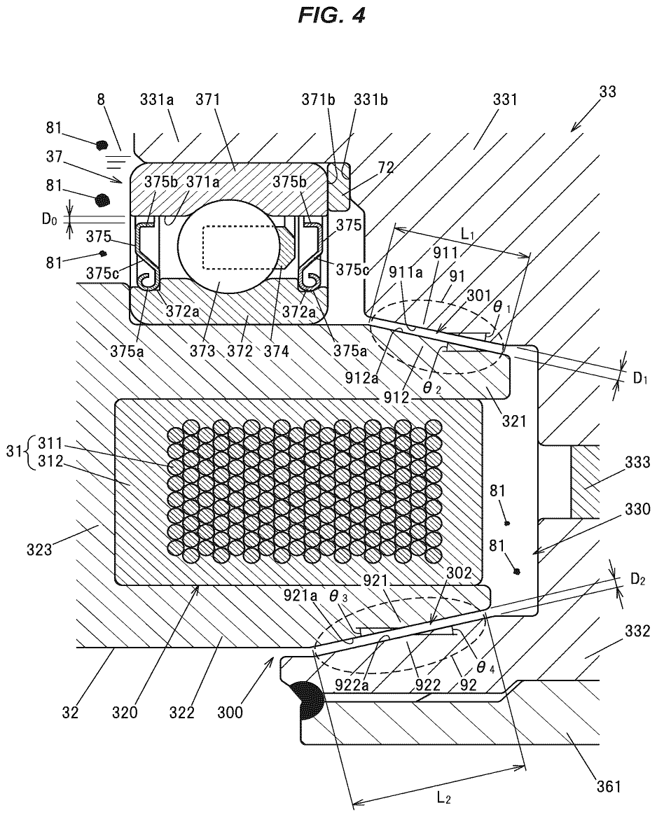

FIG. 2 is a sectional view showing the driving force transmission device 2 housed in the housing portion 130 together with the first shaft 134 and the second shaft 135. FIG. 2 shows the driving force transmission device 2 in a cross section taken along a rotation axis O of the first shaft 134 and the second shaft 135. FIG. 3 is an enlarged view showing an enlargement of part of FIG. 2. FIG. 4 is a main part enlarged view showing a further enlargement of portion A in FIG. 3. Hereinafter, a direction parallel to the rotation axis O will be referred to as axial direction. When the driving force transmission device 2 is mounted on the vehicle 1, the rotation axis O is horizontal.

In FIGS. 2 to 4, the up-down direction of the drawings corresponds to an up-down direction of the vertical direction of the driving force transmission device 2 mounted on the vehicle 1. FIG. 2 shows an oil surface 80 of lubrication oil 8 in a state in which the vehicle 1 is at a standstill and the driving force transmission device 2 is not rotating. FIG. 3 shows part of the driving force transmission device 2 below the rotation axis O. Oil seals 130a, 130b are attached to the case body 131 and the case cover 132 of the transfer case 133 to prevent leakage of the lubrication oil 8 that fills the housing portion 130.

The driving force transmission device 2 includes an electromagnetic clutch 3, a cam mechanism 4 to be actuated by torque transmitted by the electromagnetic clutch 3 to generate a cam thrust, a main clutch 5 to be pressed in the axial direction by the cam thrust of the cam mechanism 4, and a cylindrical sleeve 6 interposed between the main clutch 5 and the first shaft 134. The torque transmitted by the electromagnetic clutch 3 is amplified by the cam mechanism 4 and the main clutch 5, and the driving force is transmitted from the first shaft 134 to the second shaft 135 through the sleeve 6 and the main clutch 5.

The inner circumferential surface of the sleeve 6 includes a plurality of inner circumferential spline protrusions 6a extending in the axial direction, and the outer circumferential surface of the sleeve 6 includes a plurality of outer circumferential spline protrusions 6b extending in the axial direction. The outer circumferential surface of the first shaft 134 includes a plurality of spline protrusions 134a that engages with the plurality of inner circumferential spline protrusions 6a of the sleeve 6, and the end of the first shaft 134 is fitted to the inside of the sleeve 6 such that it is not rotatable relative to the sleeve 6.

The electromagnetic clutch 3 includes an annular electromagnetic coil 31 to be supplied with a current from the control device 18, a yoke 32 that holds the electromagnetic coil 31, a magnetic path forming member 33 that forms a magnetic path for a magnetic flux generated by the current flowing through the electromagnetic coil 31, an armature 34 to be attracted toward the magnetic path forming member 33 by the magnetic flux, a pilot clutch 35 disposed between the magnetic path forming member 33 and the armature 34 in the axial direction, a rotary housing member 36 that rotates together with the magnetic path forming member 33, and a bearing 37 disposed between the magnetic path forming member 33 and the yoke 32. The bearing 37 supports the magnetic path forming member 33 such that the magnetic path forming member 33 is rotatable relative to the yoke 32.

The rotary housing member 36 houses the magnetic path forming member 33, the armature 34, the pilot clutch 35, the cam mechanism 4, the main clutch 5, and the sleeve 6. The yoke 32, the magnetic path forming member 33, the pilot clutch 35, and the armature 34 are arranged in the axial direction, and the magnetic path forming member 33 and the pilot clutch 35 are disposed between the yoke 32 and the armature 34. The rotary housing member 36 and the magnetic path forming member 33 are disposed in the housing portion 130 of the transfer case 133 in the oil-bath state in the lubrication oil 8, and rotate relative to the yoke 32 in the oil-bath state.

The magnetic path forming member 33 includes an inner magnetic member 331 and an outer magnetic member 332 made of soft magnetic materials and disposed concentrically about the rotation axis O, and an annular non-magnetic portion 333 provided between the inner magnetic member 331 and the outer magnetic member 332. In the present embodiment, the non-magnetic portion 333 is made of a non-magnetic metal such as austenitic stainless steel. The inner magnetic member 331 and the outer magnetic member 332 are each made of, for example, a soft magnetic metal containing iron as a main component. The non-magnetic portion 333 has an inner circumferential end fixed to the inner magnetic member 331 by welding, and an outer circumferential end fixed to the outer magnetic member 332 by welding. A plain bearing 70 is press-fitted to the inner circumferential surface of the inner magnetic member 331, and the first shaft 134 is inserted into the inside of the plain bearing 70.

The magnetic path forming member 33 has an annular recess 330 centered on the rotation axis O, and the annular recess 330 houses part of the yoke 32 in the axial direction. The annular recess 330 is formed between the inner magnetic member 331 and the outer magnetic member 332, and is open opposite to the pilot clutch 35 and the armature 34 in the axial direction. The non-magnetic portion 333 is provided at the deepest portion of the annular recess 330 in the axial direction.

The rotary housing member 36 has a bottomed cylindrical shape integrally including a cylindrical portion 361 having a cylindrical shape, and a bottom portion 362 having a disc shape and provided inside the cylindrical portion 361. The inner circumferential surface of the cylindrical portion 361 includes a plurality of spline protrusions 361a extending in the axial direction. The bottom portion 362 is provided on the inside of one axial end of the cylindrical portion 361. The other axial end of the cylindrical portion 361 is screwed to the outer magnetic member 332 of the magnetic path forming member 33. A washer 71 is disposed between the bottom portion 362 and the sleeve 6.

A fitting hole 360 to which the second shaft 135 is fitted is formed at the center of the bottom portion 362, and the inner circumferential surface of the fitting hole 360 includes a plurality of spline protrusions 362a extending in the axial direction. The outer circumferential surface of the second shaft 135 includes a plurality of spline protrusions 135a. The plurality of spline protrusions 135a engages with the plurality of spline protrusions 362a formed on the inner circumferential surface of the fitting hole 360. Thus, the second shaft 135 is fitted to the rotary housing member 36 such that it is not rotatable relative to the rotary housing member 36.

As shown in FIG. 3, the pilot clutch 35 includes a plurality of pilot outer clutch plates 351 and a plurality of pilot inner clutch plates 352. The pilot outer clutch plate 351 and the pilot inner clutch plate 352 are each made of a soft magnetic metal and have an annular shape. The frictional sliding between the pilot outer clutch plate 351 and the pilot inner clutch plate 352 is lubricated by the lubrication oil 8.

The pilot outer clutch plate 351 includes a plurality of engagement protrusions 351a formed on the outer circumferential end, and has a plurality of arc-shaped slits 351b formed at a portion aligned with the non-magnetic portion 333 of the magnetic path forming member 33 in the axial direction. The plurality of engagement protrusions 351a of the pilot outer clutch plate 351 engages with the plurality of spline protrusions 361a of the rotary housing member 36. Thus, the pilot outer clutch plate 351 is movable in the axial direction and is not rotatable relative to the rotary housing member 36.

The pilot inner clutch plate 352 includes a plurality of engagement protrusions 352a formed on the inner circumferential end, and has a plurality of arc-shaped slits 352b formed at a portion aligned with the non-magnetic portion 333 of the magnetic path forming member 33 in the axial direction. The plurality of engagement protrusions 352a of the pilot inner clutch plate 352 engages with a pilot cam 41 of the cam mechanism 4 described later. Thus, the pilot inner clutch plate 352 is movable in the axial direction and is not rotatable relative to the pilot cam 41.

The armature 34 is made of a soft magnetic metal and has an annular plate shape, and includes a plurality of engagement protrusions 34a formed on the outer circumferential end. The plurality of engagement protrusions 34a engages with the plurality of spline protrusions 361a of the rotary housing member 36. Thus, the armature 34 is movable in the axial direction and is not rotatable relative to the rotary housing member 36.

The electromagnetic coil 31 includes a winding 311 through which a current supplied from the control device 18 flows. The winding 311 is sealed by a sealing member 312 that is a resin molded body. The winding 311 is, for example, an enameled wire, and is supplied with a current from the control device 18 via an electric wire 310.

The yoke 32 is made of a soft magnetic metal and has an annular shape. The yoke 32 integrally includes an inner portion 321 arranged in the axial direction with the inner magnetic member 331 of the magnetic path forming member 33, an outer portion 322 arranged in the axial direction with the outer magnetic member 332 of the magnetic path forming member 33, and a side wall portion 323 arranged in the axial direction with the electromagnetic coil 31. As shown in FIG. 2, the yoke 32 engages with a rotation stopper 131a provided on the case body 131 of the transfer case 133, and is therefore prevented from rotating relative to the transfer case 133. A housing portion 320 that houses and holds the electromagnetic coil 31 is formed between the inner portion 321 and the outer portion 322. The housing portion 320 is open in the axial direction toward the non-magnetic portion 333 of the magnetic path forming member 33.

The bearing 37 is a shielded rolling bearing, and includes an inner ring 371, an outer ring 372, a plurality of rolling elements 373 disposed between the inner ring 371 and the outer ring 372, a cage 374 that holds the plurality of rolling elements 373, and a pair of shield members 375 disposed between the inner ring 371 and the outer ring 372. As shown in FIG. 4, the shield member 375 has an annular shape, and integrally includes a fixed portion 375a fixed to the outer ring 372, a facing portion 375b that faces an outer circumferential surface 371a of the inner ring 371 via a clearance, and a wall portion 375c between the fixed portion 375a and the facing portion 375b. The outer ring 372 has annular grooves 372a formed at both axial ends, and the fixed portions 375a of the shield members 375 engage with the annular grooves 372a.

In the present embodiment, the rolling element 373 is a ball, but this is not limitative. The rolling element 373 may be, for example, a cylinder. In the present embodiment, the shield members 375 are disposed at both axial ends of the bearing 37, but the shield member 375 may be disposed at only one axial end of the bearing 37.

In the present embodiment, the shield member 375 is fixed to the outer ring 372 and the clearance is formed between the shield member 375 and the inner ring 371. Conversely, the shield member 375 may be fixed to the inner ring 371 and the clearance may be formed between the shield member 375 and the outer ring 372. That is, it is appropriate that the shield member 375 be fixed to one of the inner ring 371 and the outer ring 372 and the clearance be formed between the shield member 375 and the other of the inner ring 371 and the outer ring 372.

Of both the axial ends of the magnetic path forming member 33, the end near the yoke 32 includes an inner ring fitting portion 331a fitted to the inner ring 371 of the bearing 37. The inner ring fitting portion 331a is part of the inner magnetic member 331, and is press-fitted to the inner ring 371. A shim 72 is disposed between the inner ring 371 and the inner magnetic member 331 in the axial direction to adjust the clearance between the yoke 32 and the magnetic path forming member 33 in the axial direction. The shim 72 is arranged with the inner ring 371 in the axial direction and is sandwiched between a side surface 371b of the inner ring 371 and a shim contact surface 331b formed on the inner magnetic member 331.

The cam mechanism 4 includes the pilot cam 41 disposed inside the pilot clutch 35, a main cam 42 disposed closer to the main clutch 5 than the pilot cam 41, a plurality of rolling elements 43 disposed between the pilot cam 41 and the main cam 42, and a retainer 44 that holds the plurality of rolling elements 43. The outer circumferential surface of the pilot cam 41 includes a plurality of spline protrusions 41a with which the plurality of engagement protrusions 352a of the pilot inner clutch plate 352 engages. The pilot cam 41 rotates relative to the main cam 42 by torque transmitted from the rotary housing member 36 by the pilot clutch 35.

The main cam 42 integrally includes a cam portion 421 that faces the pilot cam 41 in the axial direction, and a pressing portion 422 that presses the main clutch 5. The pilot cam 41 has a plurality of cam grooves 41b formed on a surface that faces the cam portion 421 of the main cam 42. The cam portion 421 of the main cam 42 has a plurality of cam grooves 421a formed on a surface that faces the pilot cam 41. The cam grooves 41b, 421a extend in an arc shape along the circumferential direction, have the largest axial depth at the circumferential center, and are formed such that the axial depth gradually decreases toward both circumferential ends.

Axial movement of the pilot cam 41 away from the main cam 42 is restricted by a thrust roller bearing 73. The thrust roller bearing 73 is disposed between the inner magnetic member 331 of the magnetic path forming member 33 and a back surface 41c of the pilot cam 41.

The inner circumferential end of the pressing portion 422 of the main cam 42 includes a plurality of engagement protrusions 422a that engages with the plurality of outer circumferential spline protrusions 6b formed on the sleeve 6. Since the engagement protrusions 422a engage with the outer circumferential spline protrusions 6b, the main cam 42 is movable in the axial direction and is not rotatable relative to the sleeve 6. An elastic member 74 that biases the main cam 42 toward the pilot cam 41 is disposed between a back surface 421b of the cam portion 421 of the main cam 42 and the sleeve 6. The elastic member 74 is, for example, a wave washer, and is compressed in the axial direction.

When no current is supplied to the electromagnetic coil 31, the rolling elements 43 are located at the centers of the cam grooves 41b, 421a, and no cam thrust is generated by the cam mechanism 4. Thus, the main clutch 5 is not pressed. When a current is supplied to the electromagnetic coil 31, a magnetic flux flows through a magnetic path 30 indicated by a dashed line in FIG. 3, and the armature 34 is attracted toward the magnetic path forming member 33. The magnetic path 30 includes an inner gap 301 that is a clearance between the inner magnetic member 331 of the magnetic path forming member 33 and the inner portion 321 of the yoke 32, and an outer gap 302 that is a clearance between the outer magnetic member 332 of the magnetic path forming member 33 and the outer portion 322 of the yoke 32. The sizes of the inner gap 301 and the outer gap 302 vary depending on the thickness of the shim 72. The shim 72 used has a thickness selected such that the sizes of the inner gap 301 and the outer gap 302 have appropriate values.

When the armature 34 is attracted toward the magnetic path forming member 33, the pilot clutch 35 is pressed, and the plurality of pilot outer clutch plates 351 and the plurality of pilot inner clutch plates 352 come into frictional contact with each other. Thus, torque is transmitted to the pilot cam 41. When the pilot cam 41 rotates relative to the main cam 42, the rolling elements 43 roll along the cam grooves 41b, 421a to generate a cam thrust, and the main cam 42 presses the main clutch 5. The cam thrust increases as the current supplied to the electromagnetic coil 31 increases.

The main clutch 5 includes a plurality of main outer clutch plates 51 and a plurality of main inner clutch plates 52. The plurality of main outer clutch plates 51 and the plurality of main inner clutch plates 52 are disposed alternately in the axial direction.

As shown in FIG. 3, the main outer clutch plate 51 includes a plurality of engagement protrusions 51a formed on the outer circumferential end. The plurality of engagement protrusions 51a of the main outer clutch plate 51 engages with the plurality of spline protrusions 361a of the rotary housing member 36. Thus, the main outer clutch plate 51 is movable in the axial direction and is not rotatable relative to the rotary housing member 36.

The main inner clutch plate 52 includes a plurality of engagement protrusions 52a formed on the inner circumferential end. The plurality of engagement protrusions 52a of the main inner clutch plate 52 engages with the plurality of outer circumferential spline protrusions 6b of the sleeve 6. Thus, the main inner clutch plate 52 is movable in the axial direction and is not rotatable relative to the sleeve 6.

The frictional sliding between the main outer clutch plate 51 and the main inner clutch plate 52 is lubricated by the lubrication oil 8. The main outer clutch plates 51, the pressing portion 422 of the main cam 42, and the bottom portion 362 of the rotary housing member 36 have oil holes 51b, 422b, 362b through which the lubrication oil 8 flows, respectively.

In the cylindrical portion 361 of the rotary housing member 36, one end on an outer circumferential side of the magnetic path forming member 33 is a maximum outside diameter portion 361b having the largest outside diameter, and a small diameter portion 361c having an outside diameter smaller than that of the maximum outside diameter portion 361b is provided closer to the other end than the maximum outside diameter portion 361b. The small diameter portion 361c is a portion on an outer circumferential side of the main clutch 5 and the main cam 42.

When the rotary housing member 36 rotates about the rotation axis O, the housing portion 130 of the transfer case 133 is in an unevenly distributed state in which the lubrication oil 8 is unevenly distributed toward the yoke 32 due to the difference in outside diameter between the maximum outside diameter portion 361b and the small diameter portion 361c of the rotary housing member 36. That is, when the rotary housing member 36 rotates, the circumferential speed of the maximum outside diameter portion 361b is higher than the circumferential speed of the small diameter portion 361c. Therefore, the lubrication oil 8 flows from the small diameter portion 361c toward the maximum outside diameter portion 361b having the higher circumferential speed, and further flows from a portion on the outer circumference of the maximum outside diameter portion 361b toward the yoke 32. The lubrication oil 8 that has flowed toward the yoke 32 flows between the side wall portion 323 of the yoke 32 and the case body 131, and is supplied to the bearing 37. In FIG. 2, the flow of the lubrication oil 8 is indicated by a plurality of arrows.

The lubrication oil 8 supplied to the bearing 37 passes through the clearance between the shield member 375 and the inner ring 371 of the bearing 37, and flows through the inner gap 301 and the outer gap 302. The inner gap 301 and the outer gap 302 are adjusted to be narrow to reduce the magnetic resistance of the magnetic flux in the magnetic path 30. Therefore, when foreign matter 81 is mixed into the lubrication oil 8 as shown in FIG. 4 and the foreign matter 81 remains in the inner gap 301 or the outer gap 302, the inner gap 301 or the outer gap 302 may be clogged or the magnetic resistance of the magnetic flux in the magnetic path 30 may change. In particular, when the foreign matter 81 is iron powder, the foreign matter 81 is likely to adhere to the yoke 32 or the magnetic path forming member 33 due to the magnetic force.

In the present embodiment, as shown in FIG. 4, two inner and outer pump portions 91, 92 that generate a flow of the lubrication oil 8 between the yoke 32 and the magnetic path forming member 33 are formed by part of the yoke 32 and the magnetic path forming member 33. Of the two inner and outer pump portions 91, 92, one pump portion 91 provided on the radially inner side of the yoke 32 and the magnetic path forming member 33 is formed by part of each of the inner magnetic member 331 of the magnetic path forming member 33 and the inner portion 321 of the yoke 32, and the other pump portion 92 provided on the radially outer side of the yoke 32 and the magnetic path forming member 33 is formed by part of each of the outer magnetic member 332 of the magnetic path forming member 33 and the outer portion 322 of the yoke 32.

The pump portions 91, 92 apply a flow pressure from the radially inner side to the radially outer side of the magnetic path forming member 33 to the lubrication oil 8 between the yoke 32 and the magnetic path forming member 33, and can also be referred to as flow pressure applying portions. Hereinafter, the one pump portion 91 will be referred to as inner pump portion 91, and the other pump portion 92 will be referred to as outer pump portion 92. In FIG. 4, the inner pump portion 91 and the outer pump portion 92 are enclosed by dashed lines.

The inner pump portion 91 includes an inner tapered portion 911 having a tapered outer circumferential surface 911a, and an outer tapered portion 912 having a tapered inner circumferential surface 912a that faces the tapered outer circumferential surface 911a across the clearance. The inner tapered portion 911 is formed on the inner magnetic member 331 of the magnetic path forming member 33, and the outer tapered portion 912 is formed on the inner portion 321 of the yoke 32. The tapered outer circumferential surface 911a and the tapered inner circumferential surface 912a are parallel to each other while being inclined with respect to the axial direction, and face each other across the inner gap 301. The tapered outer circumferential surface 911a is a tapered inclined surface having an outside diameter that increases toward the deeper side of the annular recess 330. The tapered inner circumferential surface 912a is a tapered inclined surface having a bore diameter that increases toward the deeper side of the annular recess 330.

The outer pump portion 92 includes an inner tapered portion 921 having a tapered outer circumferential surface 921a, and an outer tapered portion 922 having a tapered inner circumferential surface 922a that faces the tapered outer circumferential surface 921a across the clearance. The inner tapered portion 921 is formed on the outer portion 322 of the yoke 32, and the outer tapered portion 922 is formed on the outer magnetic member 332 of the magnetic path forming member 33. The tapered outer circumferential surface 921a and the tapered inner circumferential surface 922a are parallel to each other while being inclined with respect to the axial direction. The tapered outer circumferential surface 921a is a tapered inclined surface having an outside diameter that decreases toward the deeper side of the annular recess 330. The tapered inner circumferential surface 922a is a tapered inclined surface having a bore diameter that decreases toward the deeper side of the annular recess 330.

When the magnetic path forming member 33 rotates, a centrifugal force is generated in the lubrication oil 8 in the inner gap 301, and the lubrication oil 8 flows to the deeper side of the annular recess 330 along the tapered inner circumferential surface 912a. Further, a centrifugal force is generated in the lubrication oil 8 in the outer gap 302, and the lubrication oil 8 flows from the deeper side to the opening side of the annular recess 330 along the tapered inner circumferential surface 922a. This flow of the lubrication oil 8 can prevent the foreign matter 81 from remaining in the inner gap 301 or the outer gap 302 to clog the inner gap 301 or the outer gap 302. Further, the foreign matter 81 can be prevented from flowing back together with the lubrication oil 8 from an outlet portion 300 of the channel of the lubrication oil 8 between the yoke 32 and the magnetic path forming member 33 to enter the space between the yoke 32 and the magnetic path forming member 33. The outlet portion 300 is a portion between the axial end of the outer magnetic member 332 of the magnetic path forming member 33 and the outer portion 322 of the yoke 32.

A length L₁ of the channel of the lubrication oil 8 between the tapered outer circumferential surface 911a and the tapered inner circumferential surface 912a of the inner pump portion 91 and a length L₂ of the channel of the lubrication oil 8 between the tapered outer circumferential surface 921a and the tapered inner circumferential surface 922a of the outer pump portion 92 are desirably 5 mm or more, and more desirably 10 mm or more. By setting L₁ and L₂ to 5 mm or more, an increase in magnetic resistance in the inner pump portion 91 and the outer pump portion 92 is suppressed. When L₁ and L₂ are 10 mm or more, an increase in magnetic resistance in the inner pump portion 91 and the outer pump portion 92 is sufficiently suppressed, and torque can be secured.

A taper angle θ₁ of the tapered outer circumferential surface 911a and a taper angle θ₂ of the tapered inner circumferential surface 912 a in the inner pump portion 91 are desirably the same angle, and a taper angle θ₃ of the tapered outer circumferential surface 921a and a taper angle θ₄ of the tapered inner circumferential surface 922a in the outer pump portion 92 are desirably the same angle. Therefore, the separation distance between the tapered outer circumferential surface 911a and the tapered inner circumferential surface 912a of the inner pump portion 91 is the same over the entire length L₁ of the channel, and there is no significant difference in magnetic resistance between the radially inner side and the radially outer side of the inner pump portion 91. Thus, magnetic saturation can be suppressed in the inner pump portion 91. Further, the separation distance between the tapered outer circumferential surface 921a and the tapered inner circumferential surface 922a of the outer pump portion 92 is the same over the entire length L₂ of the channel, and there is no significant difference in magnetic resistance between the radially inner side and the radially outer side of the outer pump portion 92. Thus, magnetic saturation can be suppressed in the outer pump portion 92. The taper angles θ₁ to θ₄ are angles of the tapered outer circumferential surface 911a and the tapered inner circumferential surface 912a of the inner pump portion 91 and the tapered outer circumferential surface 921a and the tapered inner circumferential surface 922a of the outer pump portion 92 with respect to the axial direction.

The taper angles θ₁ to θ₄ are preferably 5° (deg) or more to exert a pumping action sufficient to expel the foreign matter that has entered the inner gap 301 and the outer gap 302, and are preferably 40° or less to secure the magnetic path areas of the inner gap 301 and the outer gap 302. If the taper angles θ₁ to θ₄ are equal to or more than about 45°, the magnetic path areas of the inner gap 301 and the outer gap 302 decrease to cause an increase in magnetic resistance.

The lubrication oil 8 is supplied to the inner pump portion 91 and the outer pump portion 92 from the space between the yoke 32 and the inner end of the magnetic path forming member 33 near the yoke 32. In the present embodiment, the end of the magnetic path forming member 33 near the yoke 32 is the inner ring fitting portion 331a, and the bearing 37 is disposed between the inner ring fitting portion 331a and the yoke 32. The lubrication oil 8 that has passed through the clearance between the shield member 375 and the inner ring 371 of the bearing 37 is supplied to the inner pump portion 91 and the outer pump portion 92. Therefore, the shield member 375 and the inner ring 371 of the bearing 37 function as a filter portion that suppresses the flow of the foreign matter 81 in the lubrication oil 8 toward the inner pump portion 91 and the outer pump portion 92. In other words, the shield member 375 and the inner ring 371 of the bearing 37 constitute the filter portion that suppresses the flow of the foreign matter 81 in the lubrication oil 8 toward the inner pump portion 91 and the outer pump portion 92.

Assuming that the clearance between the facing portion 375b of the shield member 375 and the outer circumferential surface 371a of the inner ring 371 in the bearing 37 is D₀, the size of the clearance between the tapered outer circumferential surface 911a and the tapered inner circumferential surface 912a of the inner pump portion 91 is D₁, and the size of the clearance between the tapered outer circumferential surface 921a and the tapered inner circumferential surface 922a of the outer pump portion 92 is D₂, D₀ is smaller than D₁ and D₂. For example, D₀ is less than 0.2 mm, and D₁ and D₂ are 0.2 mm or more and 0.3 mm or less.

In this way, the foreign matter passage diameter of the clearance between the shield member 375 and the inner ring 371 of the bearing 37 is smaller than the size of the clearance between the tapered outer circumferential surface 911a and the tapered inner circumferential surface 912a of the inner pump portion 91 and the size of the clearance between the tapered outer circumferential surface 921a and the tapered inner circumferential surface 922a of the outer pump portion 92. The foreign matter passage diameter refers to the maximum diameter of foreign matter that can pass through the clearance between the shield member 375 and the inner ring 371 of the bearing 37 assuming that the foreign matter is spherical. With this configuration, the foreign matter 81 that is too large to pass through the inner gap 301 and the outer gap 302 can be prevented from entering the inner gap 301 and the outer gap 302.

### Effects of Embodiment

According to the embodiment described above, the pumping action of the inner pump portion 91 and the outer pump portion 92 causes the lubrication oil 8 between the yoke 32 and the magnetic path forming member 33 to flow toward the outlet portion 300. Thus, it is possible to suppress clogging of foreign matter between the yoke 32 and the magnetic path forming member 33. Due to the difference in outside diameter between the maximum outside diameter portion 361b and the small diameter portion 361c of the cylindrical portion 361 of the rotary housing member 36, the lubrication oil 8 collects near the yoke 32 within the housing portion 130 when the rotary housing member 36 rotates in the oil-bath state. Thus, a sufficient amount of the lubrication oil 8 can be supplied between the yoke 32 and the magnetic path forming member 33. The bearing 37 functions as the filter portion. Thus, it is possible to suppress entry of the large foreign matter 81 into the space between the yoke 32 and the magnetic path forming member 33. No hardened layer is formed on the yoke and the magnetic path forming member as in Patent Document 1 above. Thus, the driving force transmission device 2 can be made inexpensive and have excellent magnetic characteristics.

### Additional Notes

Although the present invention is described above based on the embodiment, the embodiment is not intended to limit the invention according to the claims. It should be noted that not all the combinations of features described in the embodiment are essential to means for solving the problem in the invention. The present invention can be modified as appropriate by omitting part of the configurations or adding or replacing configurations without departing from the spirit and scope of the present invention. For example, the present invention can be carried out in the following modifications (1) to (5).
(1) In the above embodiment, the configuration of the vehicle 1 when the driving force transmission device 2 is used as the transfer 13 is described with reference to FIG. 1. However, the configuration of the vehicle is not limited to this. For example, the driving force transmission device 2 may be disposed between the rear end of the propeller shaft extending from the transmission and the differential device 17 on the rear wheel side, or the driving force transmission device 2 may be disposed between the differential device 17 and the left drive shaft 161 or the right drive shaft 162.
(2) The above embodiment illustrates the case where the electromagnetic clutch 3 includes the inner pump portion 91 and the outer pump portion 92. However, this is not limitative. One of the inner pump portion 91 and the outer pump portion 92 may be omitted.
(3) The above embodiment illustrates the case where the bearing 37 is used as the filter portion. However, this is not limitative. For example, a mesh filter may be used to suppress entry of the large foreign matter 81 into the space between the yoke 32 and the magnetic path forming member 33.
(4) The above embodiment illustrates the case where the driving force transmission device 2 is formed by combining the electromagnetic clutch 3 with the cam mechanism 4 and the main clutch 5. Depending on the application and the torque transmission capacity, the electromagnetic clutch 3 may be used alone.
(5) The above embodiment illustrates the case where the electromagnetic clutch 3 is a multi-disc friction clutch including the plurality of pilot outer clutch plates 351 and the plurality of pilot inner clutch plates 352. However, this is not limitative. The pilot clutch 35 may be omitted, and a single-disc friction clutch that transmits torque by friction between the armature 34 and the magnetic path forming member 33 may be used.

### Reference Signs List

3 ELECTROMAGNETIC CLUTCH
301 INNER GAP
302 OUTER GAP
31 ELECTROMAGNETIC COIL
32 YOKE
321 INNER PORTION
322 OUTER PORTION
33 MAGNETIC PATH FORMING MEMBER
331 INNER MAGNETIC MEMBER
332 OUTER MAGNETIC MEMBER
333 NON-MAGNETIC PORTION
34 ARMATURE
36 ROTARY HOUSING MEMBER
361b MAXIMUM OUTSIDE DIAMETER PORTION
361c SMALL DIAMETER PORTION
37 BEARING
371 INNER RING
372 OUTER RING
375 SHIELD MEMBER
8 LUBRICATION OIL
81 FOREIGN MATTER
91 INNER PUMP PORTION
911 INNER TAPERED PORTION
911a TAPERED OUTER CIRCUMFERENTIAL SURFACE
912 OUTER TAPERED PORTION
912a TAPERED INNER CIRCUMFERENTIAL SURFACE
92 OUTER PUMP PORTION
921 INNER TAPERED PORTION
921a TAPERED OUTER CIRCUMFERENTIAL SURFACE
922 OUTER TAPERED PORTION
922a TAPERED INNER CIRCUMFERENTIAL SURFACE

1. An electromagnetic clutch comprising:
an annular electromagnetic coil;
a yoke that holds the electromagnetic coil;
a magnetic path forming member that forms a magnetic path for a magnetic flux generated by a current flowing through the electromagnetic coil;
and an armature to be attracted toward the magnetic path forming member by the magnetic flux, the magnetic path forming member being configured to rotate relative to the yoke in an oil-bath state, wherein
a pump portion that generates a flow of lubrication oil between the yoke and the magnetic path forming member is formed by part of each of the magnetic path forming member and the yoke,
the pump portion includes an inner tapered portion having a tapered outer circumferential surface, and an outer tapered portion having a tapered inner circumferential surface that faces the tapered outer circumferential surface across a clearance, and
the inner tapered portion is formed on one of the magnetic path forming member and the yoke, and the outer tapered portion is formed on the other of the magnetic path forming member and the yoke.

2. The electromagnetic clutch according to claim 1, wherein:
the magnetic path forming member includes an inner magnetic member and an outer magnetic member made of soft magnetic materials, and an annular non-magnetic portion provided between the inner magnetic member and the outer magnetic member;
the yoke includes an inner portion arranged in an axial direction with the inner magnetic member of the magnetic path forming member, and an outer portion arranged in the axial direction with the outer magnetic member of the magnetic path forming member;
the pump portion includes two inner and outer pump portions formed by part of each of the magnetic path forming member and the yoke; and
one of the pump portions is formed by part of each of the inner magnetic member of the magnetic path forming member and the inner portion of the yoke, and the other of the pump portions is formed by part of each of the outer magnetic member of the magnetic path forming member and the outer portion of the yoke.

3. The electromagnetic clutch according to claim 1, wherein:
the yoke, the magnetic path forming member, and the armature are arranged in an axial direction, and the magnetic path forming member is disposed between the yoke and the armature;
a rotary housing member that houses the magnetic path forming member and the armature and rotates together with the magnetic path forming member is provided, and the rotary housing member is disposed in a case in the oil-bath state;
the rotary housing member rotates in the oil-bath state to cause an unevenly distributed state in which the lubrication oil is unevenly distributed toward the yoke in the case; and
the lubrication oil is supplied to the pump portion from a space between the yoke and an end of the magnetic path forming member near the yoke.

4. The electromagnetic clutch according to claim 3, wherein:
one end of the rotary housing member on an outer circumferential side of the magnetic path forming member is a maximum outside diameter portion having a largest outside diameter, and a small diameter portion having an outside diameter smaller than the outside diameter of the maximum outside diameter portion is provided closer to another end than the maximum outside diameter portion; and
when the rotary housing member rotates in the oil-bath state, the lubrication oil is unevenly distributed toward the yoke in the case due to a difference in the outside diameter between the maximum outside diameter portion and the small diameter portion of the rotary housing member.

5. The electromagnetic clutch according to claim 3, wherein a filter portion that suppresses a flow of foreign matter in the lubrication oil toward the pump portion is provided between the end of the magnetic path forming member and the yoke.

6. The electromagnetic clutch according to claim 5, wherein a foreign matter passage diameter of the filter portion is smaller than a size of the clearance between the tapered outer circumferential surface and the tapered inner circumferential surface of the pump portion.

7. The electromagnetic clutch according to claim 5, further comprising a bearing that supports the magnetic path forming member such that the magnetic path forming member is rotatable relative to the yoke, the bearing being disposed between the end of the magnetic path forming member and the yoke, wherein
the bearing includes an inner ring, an outer ring, a plurality of rolling elements disposed between the inner ring and the outer ring, and a shield member fixed to one of the inner ring and the outer ring and having a clearance formed between the shield member and the other of the inner ring and the outer ring,
the other of the inner ring and the outer ring and the shield member constitute the filter portion, and
a size of the clearance between the other of the inner ring and the outer ring and the shield member in a radial direction of the bearing is smaller than a size of the clearance between the tapered outer circumferential surface and the tapered inner circumferential surface of the pump portion.
